(19) United States
(12) Patent Application Publication
(10) Pub. No.: US 2005/0153610 A1
(43) Pub. Date: Jul. 14, 2005

(54) Particulate filled fluoropolymer coating composition and method of making article therefrom

(75) Inventor: Thomas F. McCarthy, Bennington, VT (US)

Correspondence Address: HESLIN ROTHENBERG FARLEY & MESITI PC, 5 COLUMBIA CIRCLE, ALBANY, NY, 12203, US

(73) Assignee: Tonoga Inc., Petersburgh, NY (US)

(21) Appl. No.: 10/756,738

(22) Filed: Jan. 13, 2004

(51) Int. Cl. B32B 3/00

(52) U.S. Cl. 442/59

(57) ABSTRACT

Processes for preparing an electrical substrate material include combining a ceramic modifier, a fluoropolymer coating composition and a silicone oil comprising a methyl-terminated polydimethyl siloxane, to yield a particle filled fluoropolymer coating composition. The fluoropolymer coating composition is applied to a fabric substrate to yield an electrical substrate material.

### BACKGROUND OF THE INVENTION

A variety of different processes have been proposed for fabrication of ceramic filled fluoropolymeric composites. These include the coating of ceramic filled PTFE dispersion on a woven or non-woven reinforcement substrate or web, (see Chellis et al. U.S. Pat. No. 5,126,192), the casting of this material on a smooth carrier belt or film from which the cast layer can be removed, (see Markovich et al. U.S. Pat. No. 5,045,342) extruding a ceramic filled molten polymer and calendaring the resulting product to the desired thickness, forming a paste extrusion of the ceramic filled fluoropolymer and calendaring the material so that it can be skived. In all the above cases the dielectric constant (Dk) of the composite is directly related to the content and dielectric characteristics of the fluoropolymer, usually polytetrafluoroethylene (PTFE), the Dk of the ceramic modifier and any contribution due to air. Any reinforcement material that is used in preparing the product will also influence these parameters. The industry has demanded higher dielectric constants than that of pure PTFE and variations thereof. The industry has also demanded composites of low dielectric constant that have high levels of ceramic dielectric modifiers yet do not absorb moisture.

While polytetrafluoroethylene (PTFE) is a preferred fluoropolymer for this general purpose, the material can be challenging due to the possible incomplete fusion of the primary particles into a continuous film, and possibly because of its propensity to fibrillate, both of which lead to voids in the material that increase porosity and ultimately water absorption. Aqueous dispersions of PTFE contain submicron particles that fuse together at points. PTFE does not flow like an injection moldable polymers. The particles fuse at points. Densification of the particles occurs during high temperature lamination reducing the amount of air between the particles. Air, however, is always present in the void spaces of the particles and within the fiberglass that is not fully impregnated. Ceramic modifiers impact the film formation of the PTFE particles. Ceramic modifiers additionally may have a chemical makeup at their surfaces that attracts moisture. It is the preferred embodiment of this invention that the ceramic particles and any void spaces contain a moisture resistant material. The introduction of small quantities of a polymeric siloxane oil, preferably terminated so as to be non-reactive will improve the film forming characteristics of the PTFE and impart a degree of moisture resistance to the ceramic particles. Selected composites that are prepared from ceramic particles having large particle sizes may be more likely to absorb moisture simply due to the fact that more void space might be present during film formation such that moisture vapor may enter the void although there is little or minor chemical interaction with the surface chemistry of the particle. High temperature lamination will work to reduce the amount of air entrainment, with higher and higher temperatures and pressures leading to less air left in the composite, however air cannot be altogether eliminated. Smaller ceramic particles have a higher surface area and therefore a greater quantity of chemical moieties that could attract moisture. PFA, TFE and HFP or other copolymers of tetrafluoroethylene can be added in small quantities (2 or 10%) to improve the film forming characteristics of the PTFE matrix material and to yield a composite having less void space.

In many cases, the particulate ceramic modifiers chosen for a particular application in a PTFE composite to fulfill certain design parameter requirements dictate the use of one or more of the following particulate fillers: alumina, titanium dioxide, strontium titanate, fused silica, magnesia, quartz, boron nitride, boron nitrate, silicon nitride, aluminum nitride, silicon carbide, beryllia and barium titanate. At times it is advantageous to employ a polymeric filler.

The present invention is not related specifically to the use of such polymeric fillers, and preferably in accordance with the present invention ceramic fillers are preferred for the express purpose of achieving a design value of dielectric coefficient (Dk) and/or to make the coefficient of thermal expansion (CTE) of the substrate more compatible with the conductive layer, usually a particular metal as for example copper.

The present invention seeks to provide an improved approach to utilizing high molecular weight fluoropolymers that exhibit poor film formation properties and a propensity to fibrillate. One of the disadvantages to employing such a fluoropolymer with the required amounts of ceramic modifier is the necessity for drilling the resulting substrates by those who must fabricate the necessary circuitry for present day cell phones and base stations. While laser drilling has been proposed as an alternative to mechanical drilling, the choice and volumetric content of ceramic materials has been found to be critical in connection with satisfying this requirement in fabricating microwave circuit board materials. The present invention provides for up to 70 wt % filled fluoropolymer resin suitable for coating on a fiberglass cloth substrate.

Another purpose of the present invention is to eliminate the perceived need alluded to in the prior art suggesting that hydrophobic coatings such as silanes, zirconates, or titanates be used to treat the filler materials to be used in an aqueous dispersion of polytetrafluoroethylene (PTFE) and filler particles. Reexamined U.S. Pat. Nos. B1 5,384,181, 5,506,049 C1, and B1 5,312,576, like U.S. Pat. No. 5,126,192, disclose the use of reactive organo silanes to treat the surface of an inorganic particle to make ceramic-PTFE composites in order to reduce the moisture absorption of the ceramic particles. U.S. Pat. No. 5,182,173 describes the use of a reactive silicone elastomer comprising the reaction product of a multifunctionally terminated polysiloxane and a multifunctional silane. U.S. Pat. No. 5,182,173 describes reacting a “reactive silicone network” derived from a multifunctional terminated polysiloxane reacted with a silane cross linking agent, with an inorganic particle. U.S. Pat. No. 5,182,173 teaches away from non reactive methyl terminated polydimethylsiloxanes by stating that “non reative groups include phenyl and alkyl groups” and U.S. Pat. No. 5,182,173 prescribes a very detailed list of reactive functionalities that is contemplated and required for their invention. As suggested by the prior art, suitable reactive monofunctional or multifunctional groups included silane, hydride, vinyl, and alkoxy functionalized polydimethylsiloxanes. Japanese patent 03068158 describes the treatment of silica with a combination of an organosilane and a functionalized siloxane for use in epoxy matrices. Japanese patent 2003003077 teaches the use of a siloxane, a ceramic filler, and a thermoplastic for injection molding applications. Japanese patents 08127671 and 3131677 teach the use of an organosilane combined with a polydimethylsiloxane to treat fillers that are useful in rubbers, plastics, sealants, and coatings. Envisioned in this embodiment, contrary to prior teachings, is a non-reactive polydimethylsiloxane that assists in film formation and helps to reduce moisture absorption by becoming reactive at the temperatures required to process PTFE.

### SUMMARY OF THE INVENTION

In one aspect, the present invention relates to a process for preparing a particle filled fluoropolymer coating composition for application to a substrate. The process includes combining a ceramic filler material, a fluoropolymer coating composition and a silicone oil comprising a methyl-terminated polydimethyl siloxane, to yield a particle filled fluoropolymer emulsion composition suitable for dip coating a substrate.

In another aspect, the present invention relates to a process for preparing an electrical substrate material. The process includes combining a ceramic filler material, a first fluoropolymer coating composition and a silicone oil comprising a methyl-terminated polydimethyl siloxane, to yield a particle filled fluoropolymer coating composition and applying at least one coat of the first fluoropolymer coating composition to a fabric substrate.

In yet another aspect, the present invention relates to a composite material comprising a reinforcing substrate impregnated with a fluoropolymer composition. The fluoropolymer composition includes a ceramic filler material, a silicone oil and a fluoropolymer resin, and the silicone oil includes a methyl-terminated polydimethyl siloxane.

### DETAILED DESCRIPTION OF THE INVENTION

The present invention relates to processes for preparing an electrical substrate material. In these processes, a particulate ceramic modifier is combined with a fluoropolymer coating composition and an aqueous emulsified silicone oil comprising a methyl-terminated polydimethyl siloxane, to yield a particle filled fluoropolymer coating composition. The fluoropolymer coating composition is applied to a substrate.

Silicone oils for use in a coating composition according to the processes of the present invention include any polydimethyl siloxane (PDMS) polymer wherein the chain ends are capped with non-reactive methyl groups, also referred to as methyl-terminated polydimethyl siloxanes. These silicone oils are widely available. Molecular weight of the siloxane polymer should be sufficiently high so that the materials are nonvolatile at processing temperatures, or incompletely volatilize at the fabrication temperatures envisioned, a molecular weight typically greater than 1000 Daltons being preferred. The silicon oils are preferably used in the form of an aqueous dispersion; such compositions are commercially available from Silchem, Virginia Beach, Va.

Suitable substrates to be coated by the fluoropolymer coating composition include woven and non-woven fabrics, fluoropolymer precoated woven and non-woven fabrics, crossplies of unidirectional tape, polymeric films and metallic films. Woven and non-woven fabrics are preferred; these may be prepared from glass filaments or filaments based on various polymers. Woven fiberglass substrates are particularly preferred.

Reinforced composites based on a woven glass substrate may be prepared from glass styles E, D, S, or NE, or mixtures thereof. Newly developed NE glass styles available from Nittobo (Japan) have lower loss characteristics but have a cost disadvantage. Glass fabric based on 4-6 micron filaments is preferred from a drilling perspective. Typical glass styles that are preferred include: 106, 1080, 2112, 2113, 2116, and 7628. For laser drilling applications the smaller diameter based glass fabrics are preferred. The fiberglass is preferably largely free of sizing agents used to weave fiberglass and should be treated with a silane coupling agent to resist wet chemical migration and to improve the adhesion of the fiberglass reinforcement to the silane containing first impregnation pass of fluoropolymer. A lack of silane may lead to defective areas where the substrate has been mechanically drilled as indicated by white halos around the holes. For these reasons standard PTFE impregnated fiberglass that might be used in industrial applications is typically not suitable for electrical laminate applications. Flat glasses may also be used. These are woven fiberglasses derived from low twist or zero twist yams. In the weaving process, yam bundles are typically twisted such that they can be readily woven without the bundles losing their integrity. Generally the warp yams are pulled under tension through a device and the fill yarns are inserted across the rows of warp yarns using a rapier or air jet loom, for example. Low twist yams have straighter filaments than can be more readily flattened. The fiberglass can be prepared by starting with zero or low twist yams that may or may not be somewhat flat or they can be flattened in a post weaving process where the yams are mechanically flattened or the yams can be flattened due to an impinging spray. Woven glass fabrics are particularly suitable as substrates for the composite material of the present invention. Examples of such woven glass include 7628, 1080, or 106 style glasses with a 508 heat cleaned finish produced by Hexcel Schwebel.

Non-woven fabric has the advantage that very thin laminates can be prepared. Because the fibers are random, improved drilled holes can be obtained, regardless of the drilling technique, laser or mechanical. Low in-plane CTE results in exceptional layer-to-layer registration. The non-woven fabric can be coated roll to roll in a typical dipcoating process or alternatively staple-pulped fiber can be added to an aqueous PTFE dispersion and coated onto a release substrate.

Suitable organic polymeric fibers for fabrics composed of filaments based on polymers include: PTFE or other fluoropolymer fibers; polyaramides such as Teijin's Technora based on p-phenylenediamine and 3,4′-diaminodiphenylether, meta aramids such as Nomex® based on poly(m-phenyleneisophthalamide); liquid crystalline polyesters such as those based on hydroxynapthoic acid and hydroxybenzoic acid; polyetheretherketones (PEEK®, available from Victrex USA); polybenzoxazole (PBO, available from Toyobo); and polyimides. These polymeric fibers can be used to make woven fabrics or they can be chopped or pulped and used to make non-woven fabrics. In the preparation of non-woven fabrics, blends of different fibers might be used, or blends containing chopped glass fiber can be used.

In some embodiments, a fluoropolymer coating can be applied to the fabric by hot roll laminating a fluoropolymer film or a fluoropolymer skived material into the fabric thus eliminating the need for multiple coating passes. The film may or may not contain a ceramic filler.

Metallic films for use as a substrate for the composite material of the present invention include copper, aluminum, and the various grades of steel. Polymeric films include Kapton® (available from Dupont), and Upilex® (available from UBE industries), a polyimide based on biphenyltetracarboxylic dianhydride and either of p-phenylenediamine or 4,4′diaminodiphenylether.

Fluoropolymers for use in the processes and composite materials of the present invention include polytetrafluoroethylene (PTFE) and modified polytetrafluoroethylene. Modified PTFE contains from 0.01% to 15% of a comonomer which enable the particles to fuse better into a continuous film. PTFE is typically modified with a small quantity of a fluorinated alkyl vinyl ether, vinylidene fluoride, hexafluoropropylene, chlorotrifluoroethylene, and the like. High level of modification leads to polymers such as PFA poly(perfluorinatedalkylvinylether-tetrafluoroethylene) or FEP poly(perfluorinated tetrafluoroethylene-hexafluoropropylene). Other fluoropolymers which may be used include: polychlorotrifluoroethylene; copolymers of chlorotrifluoroethylene with vinylidene fluoride, ethylene, tetrafluoroethylene, and the like; polyvinylfluoride; polyvinylidene fluoride; and copolymers or terpolymers of vinylidene fluoride with TFE, HFP, and the like; and copolymers containing fluorinated alkylvinylethers. Other fluorinated, non-fluorinated, or partially fluorinated monomers that might be used to manufacture a copolymer or terpolymer with the previously described monomers might include: perfluorinated dioxozoles or alkyl substituted dioxozoles; perfluorinated or partially fluorinated butadienes; vinylesters; alkylvinyl ethers; and the like. Hydrogenated fluorocarbons from C2-C8 are also envisioned. These would include trifluoroethylene, hexafluoroisobutene, and the like. Fluoroelastomers may also be employed, including: copolymers of vinylidene fluoride and hexafluoropropylene; copolymers of hexafluoropropylene, vinylidene fluoride, and tetrafluoroethylene; copolymers of vinylidene fluoride and perfluoroalkyl vinylethers with or without tetrafluoroethylene; copolymers of tetrafluoroethylene with propylene; copolymers of tetrafluoroethylene with perfluoroalkylvinylethers; a terpolymer of propylene, vinylidene fluoride, and tetrafluoroethylene. Fluoroelastomers can be cured using the following crosslinking agents: diamines (hexamethylenediamine); a bisphenol cure system (hexafluoroisopropylidene diphenol); peroxide (2,5-dimethyl-2,5-dit-butyl-peroxyhexane); and any base that can act as a dinucleophile. In some cases it might be preferred to incorporate a cure site monomer into the polymer backbone to promote curing. These might include halogen-containing olefins such as 1-bromo-2,2-difluoroethylene or 4-bromo-3,3,4,4-tetrafluoro-butene. Other cure site monomers might include nitrile containing vinylethers and hydrogen containing olefins.

Fluoropolymer dispersions that (1) readily rewet (2) are available at low cost and (3) have low dielectric loss characteristics are preferred. Aqueous dispersions of fluoropolymers can contain a particle size from 1 nanometer to 1000 nanometers. The particle size of the fluoropolymer dispersion is not important as long as the substrate can be well impregnated. Microemulsions or blends of conventional fluoropolymer dispersions with aqueous microemulsions are also suitable. The fluoropolymer component may also be coated from a solvent vehicle onto the reinforcement.

Ceramic filler materials for use in the processes and composite materials of the present invention typically may be quartz, alumina, titanium dioxide, strontium titanate, barium titanate, alumina, silica (fused, colloidal, or crystalline), chopped glass fiber, magnesia, aluminum silicate (kaolin), steatite, zircon, quartz, boron nitride, silicon nitride, aluminum nitride, silicon carbide, talc, beryllia, barium titanate, mica, hollow or solid glass spheres, or mixtures thereof. Preferred ceramics are fused silica, alumina, strontium titanate and titanium dioxide.

The electrical substrate material or prepreg can be prepared by impregnating the substrate, for example, woven fiberglass, in a roll to roll fashion using a dip-coating process or a dual reverse roll coating process. Sequential buildup facilitates the manufacturing of the overall composite. Woven glass fabric is conveniently impregnated with PTFE dispersion or a common fluoropolymer aqueous dispersion in a multi-pass process to a desired thickness or build weight. Coating is continued until a homogenous sheet is formed where the glass fabric may or may not be completely coated.

When the substrate is woven fiberglass or nonwoven fiberglass and the fluoropolymer resin is a fluoropolymer such as PTFE, it is preferred that the initial coating of the reinforcement occur by depositing a silane containing PTFE dispersion onto a silane treated fabric. Good adhesion between the reinforcement (fiberglass fabric) and the fluoropolymer resin (PTFE) is desirable, as a lack of adhesion between the two components may lead to poor peel strengths, blistering during thermal excursions during the preparation of printed circuit boards, mechanical separation of the laminates during routing, and separation around drilled plated through holes that manifests itself as white halos. The first deposition of the fluoropolymer is typically conducted at low enough viscosities to obtain good adhesion of the resin to the reinforcement as well as good PTFE impregnation into the microfilaments. If a waterborne fluoropolymer, such as a PTFE emulsion, is used the viscosity of the initial coating should not compromise the initial impregnation into the reinforcement. A viscosity greater than 20 cp may compromise this impregnation, with viscosities greater than 100 cp very likely to compromise the adhesion of the resin to the fiberglass. For these reasons, it is preferred that the fluoropolymer is deposited onto the reinforcement in a layered fashion, such that the first layer contains no ceramic filler material that would impact the adhesion to the reinforcement and leave voids in the fiberglass, followed by subsequent layers that may or may not contain ceramics.

These ceramic filled fluoropolymer substrates might be used as precursors to create hybrid composites with thermosetting resins. Such hybrids are described in U.S. Pat. No. 6,500,529 B1. The process described herein could be used to produce low loss substrates upon which a thermosetting resin is deposited for low temperature lamination.

Flame-retardants compounds or composition may also be included in a composite or prepreg according to the present invention. Organic compounds containing phosphor are known to be suitable replacements for bromine containing organics. Triphenyl phosphate and polymer-based phosphates would be further examples.

In some embodiments the composite material may be laid up with layers of skived PTFE film in a stack.

Essentially any printed circuit boards may be laminated together using a plurality of composite materials or prepregs according to the present invention. In particular, hybrid printed circuit boards composed of epoxy fiberglass composites, such as FR-4; or laminates comprised of any of the following: PTFE; cyanate ester; polyimide; styrene; maleic anhydride; butadiene; bismaleimide; isoprene; neoprene; polyester, and others known to those skilled in the art would be suitable.

The process described herein is intended for use in preparing a composite dispersion material of fluoropolymer and ceramic filler for use in a conventional vertical coating tower. The material may be prepared from a particulate dispersion of ceramic filler in a dispersant treated carrier liquid that is be mixed vigorously so that the ceramic filler forms a colloidal solution in the carrier liquid to provide a slurry. A water emulsified polymeric siloxane oil is added to the slurry of filler particles in the same carrier liquid. Because the emulsified siloxane oil is not anticipated to react with any components of the finished ceramic filled fluoropolymer dispersion, the water dispersed siloxane oil can be added virtually at any stage. These ingredients are mixed at high speed so as to provide a dispersion of the particulate filler in the carrier liquid, and at the same time to provide the siloxane oil throughout the slurry. A silicone based surfactant is used to help disperse the silicone oil throughout the dispersion and to assist in rewetting of the substrate during subsequent coating passes. The pH of this slurry does not have to be adjusted. According to prior art, reactive organosilanes are reacted to the surface of the ceramic particle using an acid or base catalyst or modest heating (<100° C.). Sometimes the ceramic particle is treated in the dry state, according to prior art, before the silane modified ceramic is added to the PTFE dispersion. It is the embodiment of this invention that it is not critical when the siloxane oil is added to the dispersion containing the list of formulation ingredients, so long as the siloxane oil is present during coating. This dispersion is then used to impregnate, cast, or coat over fiberglass, fiberglass containing a sizing agent, PTFE-coated fiberglass, or PTFE containing fiberglass that comprises multiple layers of coating that could include PTFE or PTFE in combination with a ceramic.

The next step is to provide the resulting soup in the dip coating tank of a coating tower so that a continuous web of fiberglass cloth, or other substrate can be drawn through the dip tank and between metering bars that are used to smooth out the surfaces of the coating. The coating is sintered, fusing the PTFE and driving off the carrier liquid and volatile components of the dispersion. The siloxane oil may partially decompose during PTFE film formation at the temperature required to fuse the PTFE particles, a temperature greater than 680° F. (360° C.), causing a reduction in molecular weight of the polydimethylsiloxanes. The somewhat degraded polydimethylsiloxane oil is believed to somewhat decompose by the loss of formaldehyde creating reactive free radicals. Some degradation of the silicone-based surfactant is also believed to occur. The silicone-based surfactant consists of an ethylene oxide-propylene oxide functionalized polydimethylsiloxane. The silicone-based surfactant is also believed to help in film formation. This coating process is repeated until the desired thickness of prepreg is prepared. Another embodiment of the invention is to add melt flowing fluoropolymers to the dispersion to assist in film formation and to fill the air voids between the PTFE particles and any air voids that might be generated from using high loadings of irregularly shaped particles. Melt flowing fluoropolymers include: perfluorinated alkylvinylether copolymers with tetrafluoroethylene, methyl, ethyl or propyl, etc., copolymers of tetrafluoroethylene and hexafluoropropylene, or any other thermally stable fluoropolymers.

According to an alternative embodiment, the glass cloth is precoated with a fluoropolymer resin dispersion that does not have a particulate filler. This is necessary to optimize the impregnation of the fiberglass monofilaments. The prepreg generally also has a final non ceramic containing adhesive coat applied in the coating tower, wherein the dip tank is filled with an unfilled PTFE dispersion to achieve a 0.1 or 0.2 mil layer of PTFE on the outer surfaces of each prepreg for better adhesion during the lamination process.

The prepreg may be calendared to densify the prepreg and the topcoats of PTFE depending on the ceramic loading and the smoothness of the prepreg. This product is then cut into sheets that are stacked with copper or any other metallic foil between caulk plates in a press where heat and pressure are applied to the laminate in accordance with a pre-determined schedule of time, heat and pressure.

The laminate is built up and layers of conductive material such as copper are provided on top and bottom surfaces of the stacks of PTFE-fiberglass-ceramic layers. The final product is compressed to yield a predetermined thickness, of 4-150 mils depending upon the number of prepreg plies or sheets utilized in the lay-up. The choice of copper styles includes rolled and electrodeposited. The copper could be zinc free or zinc containing, low profile, very low profile, reverse treat, ultralow profile, or omega foils. Copper could also be sputtered onto the faces of the composite to obtain very thin layers of copper. A layer of MFA, PFA, or skived PTFE film may optionally be added between the final stackup and the copper.

The present invention relates to the preparation of a ceramic modified PTFE dispersion of predetermined volumetric ratio, or percent, in the content of the ceramic filler relative to the whole composition of the sintered compositve after removal of the volatile components. Although these proportions are preferably on the order of 10% to 70% ceramic filler (preferably strontium titanate, titanium dioxide, or fused silica) and 10% to 90% fluoropolymer matrix, it is an important feature of the present invention that the same proportion (in this range) can be adapted for use in preparing microwave laminate circuit board material having a range of dielectric constants, as for example, in a range of between 2.5 to 30 Dk.

In a preferred embodiment a reinforced fluoropolymer matrix ceramic filled circuit board material is made to have a Dk of approximately 2 to 10. The industry has demanded materials of such Dk and having other characteristics, such as that of having a particular CTE (coefficient of thermal expansion), creating a market for such a product. Therefore, the following process is well suited for preparing a laminate that meets these criteria, and which incorporates a matrix material of these proportions.

The relatively long molecular structure of PTFE, as well its propensity to agglomerate as a dispersion, and to fibrillate when formed, under some conditions, create problems in forming products from such material. Some companies, such as Gore have turned this disadvantage into a positive by creating porous or stretched versions of the fluoropolymer. GORE-TEX is such a product.

The problems encountered in fabricating products from PTFE are compounded when ceramic particulate modifiers such as the usuals (TiO2, Silica, Carbon, glass spheres, and other readily available minerals) are used because of the propensity for such ceramics to absorb moisture or other wet chemicals common in board shop processing. Much has been written and many patents granted to various entities in an attempt to alleviate this problem. See for example U.S. Pat. No. 5,126,192 to Chellis, and U.S. Pat. Nos. 4,849,284, 5,024,871, 5,061,548, 5,077,115, 5,198,295, 5,194,326, 5,281,466, 5,312,576, 5,384,181, 5,312,576, and 5,506,049 issued to Rogers Corporation of Connecticut. These patents appear to be directed to the concept of utilizing a silane solution or its equivalent (titanate or zirconate) in the ceramic slurry, or in the mixture of PTFE dispersion and slurry, so as to provide a reactive coating to bond to the ceramic particles. Silanes are typically catalyzed by acids or bases or elevated temperatures. When silanes are reacted to a dry ceramic powder a crosslinking occurs at the surface of the particles as the silanes react with the ceramic and with themselves. When silanes are dispersed in water, they quickly form a sol gel in the aqueous solution that is a result of a build up in molecular weight, not a decrease in molecular weight. This buildup in molecular weight is ph dependent (see R. K. Iler, The Chemistry of Silica, Wiley, NY, 1979). Silanes will form a loose soluble three dimensional crosslinked network and gel at a ph less than 7. Silanes will condense to form particles at basic pH. The particles will grow in size and their number will diminish depending on the nature of the conditions. In either case it is presumed that the sol gel will collapse during the drying of the PTFE-ceramic-silane mixture such that the sol will react with the surface of the ceramic particle. It is anticipated in this invention that the polydimethylsiloxane will assist in the film formation of the PTFE primary particles and will occupy any void spaces as a partially decomposed hydrophobic oil.

Not by way of limitation, but by way of example, a preferred mixing procedure for preparing a ceramic-PTFE aqueous dispersion containing siloxane oil will be now be described in detail. More particularly, the preferred procedure calls for starting with water, preferably distilled water, and mixing this water in a high speed mixer while adding a ceramic polymeric dispersant such as Darvan 821 A (R.T. Vanderbilt) to assure a homogenous colloidal mixture of the filler. Over a period of less than 20 minutes, the desired amount of ceramic is added to the water and the dispersant. To this colloidal mixture is added a water-soluble surfactant, diluted in water, to add shear stability. To the resulting mixture is added a nonionic emulsion of siloxane oil, preferably methyl terminated poly di methyl siloxane (SEM 208 from SILCHEM), taking care to avoid creating clumps of the ceramic material in the water. To this mixture is added a siloxane-based surfactant to ensure rewetting of the dispersion over previously coated product. After this procedure has been followed, vigorous mixing is continued for a period of 15 to 20 minutes in the high-speed mixer. A dispersion of polytetrafluoroethylene is then added. This procedure requires no adjustment of pH nor is any sol gel formed. The dispersion can be immediately used. The preferred amount of siloxane is from 0.5 wt % to 5 wt % based on the total dried weight of the dispersion minus dispersants, surfactants, and water.

Still by way of the above example, the above described PTFE dispersion and the ceramic slurry solution are mixed to provide a ceramic filled fluoropolymer dispersion that is coated directly onto fiberglass cloth such as 106, 1080, or 1280 finish class from Hexcel Schwebel. It is a preferred embodiment that the fiberglass be sized with an organosilane. It is a well-known fact in the FR4 epoxy marketplace that the various styles of fiberglass have a very light sizing of organosilane. This is intended to lower the propensity of the fiberglass to absorb moisture and to help couple the fiberglass to the epoxy resin. When coating PTFE dispersions onto organosilane sized fiberglass, it is likely that the organosilane only acts to retard moisture egress into the fiberglass during pwb fabrication because the organosilane is inert to the PTFE. Because the organosilane has already condensed with the fiberglass, it is unlikely that any further reaction occurs with subsequent PTFE-ceramic coating passes. Other types of glass cloth can also be utilized, and heavier gauge glass cloth will, of course, influence the resulting dielectric constant of the resulting prepreg material. Fabrics can be flat glasses with little twist, nonwoven fiberglasses, polymeric reinforcements such as polyimides, polyesters, or polyaramides. In the presently preferred embodiment which is described here, the final dielectric constant is intended to be from 2 to 20 Dk. The fiberglass is preferably first impregnated with a PTFE dispersion containing 1-5 wt % organosilane. Multiple identical coatings of the ceramic dispersion soup are then applied to the above-mentioned glass cloth, each such coating to a weight of approximately 0.01 to 0.3 lbs. per square yard after being passed through Mayer metering rods of predetermined spacing. A final pass of pure polytetrafluoroethylene is applied to the outside of the final PTFE-ceramic pass and this final coating is also subjected to the spaced Mayer rods. This final pass is preferably without ceramic to impart interlaminar adhesion when multiple plies are used, to improve adhesion to copper, and to avoid extraneous plating during fabrication such as nickel/gold finishing. Finally, the resulting prepreg is sometimes calendared between heated rolls so as to remove any inconsistencies in the prepreg before it is cut into sheets or plies for further processing.

It is preferred embodiment to first coat the above-described organosilane sized glass cloth with a layer of unfilled PTFE mixture with organosilane. The dip tank is provided with the PTFE dispersion and organosilane absent any ceramic filler and the glass cloth is simply drawn through the dip tank. This first step can be repeated again, with the absence of organosilane, to reduce the Dk further, or the Dk can be reduced only slightly if the above-described ceramic filled coatings are applied successively after the pure PTFE. Thus a range of products of different DK can be produced with the same dispersion. This first pass impregnation with PTFE has the following benefits: (1) the non ceramic filled dispersion has a very low viscosity on or around 15 cp that leads to proper wetting of the dispersion into the fiberglass monofilaments (2) adhesion of the PTFE composite is improved by getting better anchorage of the first pass of PTFE into the fiberglass filaments (3) moisture egress is retarded by “sizing” the fiberglass with PTFE and organosilane before a ceramic-PTFE dispersion is applied. It is a preferred embodiment that this first pass of PTFE contain a low loading of organosilane (less than 5 wt %). It is believed that the organosilane in the first pass of PTFE helps to anchor the first pass of PTFE better to the organosilane sized fiberglass. Subsequent PTFE-ceramic passes would have no organosilane.

Turning now to a description of the laminating process, fourteen plies or sheets of prepreg, are stacked in a lay-up. Copper foil layers (one ounce) are provided on top of these prepreg layers. This lay-up is then placed in a press so that the caul plates of the press provide an even pressure distribution on the lay-up to an initial load of 566 psi, after which the pressure is increased to 1,000 psi as the laminate reaches its “hold” temperature. This hold temperature is preferably 700° Fahrenheit (371° C.) and is reached at a rate of 14° Fahrenheit per minute. The laminate is held at this temperature for about 75 minutes and then cooled at a controlled rate over a 4-hour period.

Laminates of different thickness can be made. Simply varying the number of plies laid up in the press will yield the desired thickness. The important feature of the present invention is that a standardized ceramic filled PTFE dispersion can be prepared in advance, and the manner in which it is used on the reinforcing glass cloth can be varied between such a dispersion and the pure PTFE dispersion so as to provide a final product exhibiting a Dk of anywhere between 3 and 15.

Still another advantage to the preparation of a standardized dispersion is that the ingredients dictate the viscosity, and the need for adjusting the viscosity to a desired range for coating on glass cloth is eliminated. The prior art shows (see U.S. Pat. No. 5,312,576) that viscosity adjustments for preparing fluoropolymer dispersions containing fillers can lead to the need for adding viscosity modifiers to the mix merely to achieve a particular viscosity. In the art of microwave circuit board manufacture adding viscosity modifiers for this purpose can lead to unanticipated effects on the physical characteristics of the final product. It is a particular benefit of this invention that the viscosity as blended is in excess of 200 cp due to the increase in viscosity that occurs by adding high loadings of ceramic particulate. Water is generally added to reduce the viscosity. In this regard water could be considered by some a viscosity modifier as could any of the ingredients although none of the ingredients are sold as viscosity modifiers or are envisioned to be used as such. The ceramic filler is provided only in the dispersion and at a level (10-65% by vol.) which will yield efficiently and economically reproducible product. The variable loading of filler will influence the viscosity.

Small particles have the advantage of a more uniform product, are easier to drill, provide better hole wall quality, and lead to less of a concern of a big particle protruding from one layer to another, possibly penetrating the metallic foil. Large particles (>10μ) have less surface area and correspondingly less surface chemistry that can attract moisture, have a resulting lower dielectric loss, require less thermoplastic resin for cohesion, and reduce cost because of some coating efficiencies. Particles sizes both above and below 10 microns are envisioned to benefit from this technology.

The addition of poly(perfluorinatedalkylvinylether-tetrafluoroethylene) copolymers, both methyl (MFA) and propyl (PFA), have the effect of lowering moisture absorption and improving moisture resistance. MFA and PFA are injection moldable fluoropolymers that will readily flow at PTFE processing temperatures. While PTFE particles will densify and fuse at points, MFA or PFA, will flow into the void spaces created by PTFE and ceramic particles. This has the effect of reducing the moisture absorption of the resulting composite. The choice of MFA or PFA is not without its own set of disadvantages, one being the higher cost. One can combine the use of polydimethylsiloxane with a melt-flowing fluoropolymer, or acceptable moisture absorptions can be obtained using only the polydimethylsiloxane fluid.

### EXAMPLES

(1-4) Example of a Ceramic Loaded PTFE-Fiberglass Composite Using Varying Loadings of a Polydimethylsiloxane.

PTFE-fiberglass-ceramic mixing formulations were mixed using the ingredients below: Darvin821A, a commercial ceramic dispersant was first added to water using a high-speed mixer. The ceramic solids were then added slowly to the mixed dispersion and allowed to mix for 20 minutes. To this solution was added polyethylene glycol with a molecular weight around 400 diluted with water, followed by a nonionic surfactant and water. SilwetL77 and Silchem208 were then added. The colloidal dispersion was then transferred to a slow speed mixer. Aqueous dispersions of fluoropolymer were then added and allowed to thoroughly mix.

Woven 1080 fiberglass that was heat cleaned and sized with an organosilane was impregnated with an aqueous dispersion of PTFE and an organosilane (3-aminopropyltriethoxysilane, 5 wt % silane of total PTFE-silane solids), having a final specific gravity of 1.320. The fiberglass increased in weight from 0.088 lbs/yd2 to 0.116 lbs/yd2. The PTFE emulsion was applied with smooth metering rods using a 2 zone vertical treater operating at 3 ft/minute having temperatures of 275 and 750 F. Ceramic filled PTFE dispersions (see Table 1) were then used to increase the coated weight on subsequent passes from 0.116 lbs/yd2 to 1.088 lbs/yd2. Coating speeds were from 6-10 ft/min using temperatures of 275/765 F and metering rods from smooth bars to 0.032″ wire bars. The PTFE-fiberglass-ceramic composite was top coated with a PTFE emulsion having a specific gravity of 1.250 using smooth wire bars raising the coated weight to 1.089. Laminates were prepared by laying up multiple plies with copper and pressing at 700 F for 60 minutes. The resulting moisture absorptions are shown in Table 1. Samples were thoroughly dried in an oven, immersed in water for 24 hours, the surface dried, and weighed for moisture pickup. These examples demonstrate that low levels of polydimethylsiloxane oil reduce the moisture absorption from the samples having little or no silicon oil.

TABLE 1
Ceramic Dispersion Mixes And The Moisture Absorptions
Measured From The Resulting Laminates

| Experiment | (1) | (2) | (3) | (4) | (5) | (C1) |
|---|---|---|---|---|---|---|
| Water | 59.1 | 59.1 | 59.1 | 88.70 | 88.70 | 30.18 |
| Ceramic dispersant | 2.7 | 2.7 | 2.7 | 3.98 | 3.98 | 1.37 |
| TiO2 | 32.5 | 32.5 | 32.5 | 48.7 | 48.7 | 11.38 |
| Silica | 59.6¹ | 59.6¹ | 59.6¹ | 89.45² | 89.45² | 36.31¹ |
| Water | 1.7 | 2.7 | 1.7 | 2.52 | 2.52 | 2.6 |
| PEG400 | 3.2 | 32.5 | 3.2 | 4.79 | 4.79 | 2.95 |
| Water | 1.7 | 1.7 | 1.7 | 2.52 | 2.52 | 2.6 |
| Nonionic surfactant | 3.2 | 3.2 | 3.2 | 4.79 | 4.79 | 2.95 |
| 3-aminopropylsilane | 0 | 0 | 0 | 0 | 0 | 0.95 |
| water | 0 | 0 | 0 | 0 | 0 | 5.0 |
| Silwet L77 | 0 | 2.0 | 2.0 | 7.47 | 7.47 | 0 |
| Silchem208 | 0.66 | 1.33 | 0 | 2.49 | 2.49 | 0 |
| Dupont 30B | 82.3 | 82.3 | 82.3 | 130.28 | 130.28 | 47.7 |
| MFA³ | 4.6 | 4.6 | 4.6 | 0.0 | 0.0 | 0 |
| Dielectric Constant at 10 GHz | 3.56 | 3.48 | 3.53 | 3.48 | — | — |
| Dissipation factor at 10 GHz⁴ | 0.0020 | 0.0020 | 0.0021 | 0.0025 | — | — |
| Moisture absorption | 0.13 | 0.09 | 0.14 | 0.12 | 0.08 | .07 |

¹GP-3I from RHI Refractories
²Minsil20 from Minco
³poly(perfluorinated methylvinylether-tetrafluoroethylene) copolymer
⁴U.S. Pat. No. 5,083,088

(5) Example of a Ceramic Loaded PTFE-Fiberglass Composite Using a Poly(perfluorinated Methylvinylether-Tetrafluoroethylene) Copolymer Topcoat.

Example 5 was prepared in the same manner as examples 1-4 with the exceptions that 108 fiberglass was used and the final top coated product before lamination used poly(tetrafluoroethylene-tetrafluoroethylene) copolymer instead of a PTFE homopolymer dispersion. This example demonstrates that the copolymer topcoat reduces moisture absorption.

(C1) Example of a Ceramic Loaded PTFE-fiberglass Composite Prepared Using an Aminosilane

This example was conducted in the same fashion as Examples 1-4 with the exception that an aminosilane was added to the formulation to reduce the moisture absorption of the filler particles. The resulting moisture absorption was within experimental error of the best examples using the polydimethylsiloxane.

(6) Example of a Strontium Titanate Loaded PTFE-fiberglass Composite with Polydimethylsiloxane.

A ceramic dispersion mix was prepared using the following procedure: 1.45 lbs of Darvan821A was added to 63.3 lbs of water on a high-speed mixer. To this was added 200 lbs of strontium titanate and 1.65 lbs of titanium dioxide. This was agitated for 20 minutes. To this was added 3.00 lbs of water and 3.08 lbs of polyethylene glycol, followed by 3.00 lbs of water and 3.08 lbs of a nonionic surfactant. To the colloidal dispersion was added 3.77 lbs of Silchem208 and 11.3 lbs of SilwetL77. The dispersion was transferred to a slow speed mixture after which 99.65 lbs (solid weight) of Daikin D6A polytetrafluoroethylene dispersion was added.

The ceramic-PTFE dispersion was coated onto 1080 style fiberglass with the following exceptions. The fiberglass was commercially partially heat cleaned and sized with 3-aminopropylsilane. The first coating pass was conducted using a 1.350 specific gravity mixture of perfluorinated (perfluorinated methylvinylether-tetrafluoroethylene) copolymer aqueous dispersion mixed with 3-aminopropyltriethoxysilane (19:1, PTFE: silane dry ratio). The fiberglass coated weight increased from 0.088 lbs/yd2 to 0.123 lbs/yd2. This PTFE-silane pass was fully fused such that no migration of silane would be expected during subsequent coating passes. Subsequent coating passes used the ceramic-PTFE dispersion described above raising the coated weight to 0.412 lbs/yd2. A light topcoat of DaikinD3A having a specific gravity of 1.275 was used. The composite was coated to a final weight of 0.436 lbs/yd2. This composite was pressed at 700 F for 80 minutes between copper foils to yield a laminate. The laminate was etched and dried. Samples were taken and dried at 150 C for 3 hr. The samples were then immersed in water for 24 hours, the surfaces dried, and the moisture uptake recorded. The moisture absorption was 0.048%. This example demonstrates that extremely low moisture absorptions can be used when no organosilane was used in the presence of the ceramic dielectric modifiers.

(7) Example of a Strontium Titanate Loaded PTFE-Fiberglass Composite with Perfluorinated(methylvinylether-tetrafluoroethylene) Copolymer.

A ceramic dispersion mix was prepared using the following procedure: 1.45 lbs of Darvan821A was added to 63.3 lbs of water on a high-speed mixer. To this was added 200 lbs of strontium titanate. This was agitated for 20 minutes. To this was added 6.70 lbs of formic acid and 26.65 lbs of water, followed by 21.65 lbs of water and 4.0 lbs of a nonionic surfactant. The dispersion was transferred to a slow speed mixture after which 89.4 lbs (solid weight) of Daikin D6A polytetrafluoroethylene dispersion and 10.25 lbs of perfluorinated(methylvinylether-tetrafluoroethylene) copolymer (solid weight), known commercially as MFA, was added.

The ceramic-PTFE dispersion was coated onto 1080 style fiberglass with the following exceptions. The fiberglass was commercially practically heat cleaned and sized with 3-aminopropylsilane. The first coating pass was conducted using a 1.350 specific gravity mixture of Daikin D6A PTFE aqueous dispersion mixed with 3-aminopropyltriethoxysilane (19:1, PTFE:silane dry ratio). The fiberglass coated weight increased from 0.088 lbs/yd2 to 0.130 lbs/yd2. This PTFE-silane pass was fully fused such that no migration of silane would be expected during subsequent coating passes. Subsequent coating passes used the ceramic-PTFE dispersion described above raising the coated weight to 0.435 lbs/yd2. A light topcoat of MFA aqueous dispersion having a specific gravity of 1.400 was used. The composite was coated to a final weight of 0.443 lbs/yd2. This composite was pressed at 700 F for 80 minutes between copper foils to yield a laminate. The laminate was etched and dried. Samples were taken and dried at 150 C for 3 hr. The samples were then immersed in water for 24 hours, the surfaces dried, and the moisture uptake recorded. The moisture absorption was 0.040%. This example demonstrates that extremely low moisture absorptions can be used when no organosilane was used in the presence of the ceramic dielectric modifiers. Melt flowing fluoropolymer can flow into any void spaces in the composite and resist moisture absorption.

1. A process for preparing a particle filled fluoropolymer coating composition for application to a substrate, said process comprising combining a ceramic filler material, a fluoropolymer coating composition and a silicone oil comprising a methyl-terminated polydimethyl siloxane, to yield a particle filled fluoropolymer emulsion composition suitable for dip coating a substrate.

2. A process for preparing an electrical substrate material, said process comprising
combining a ceramic filler material, a first fluoropolymer coating composition and a silicone oil comprising a methyl-terminated polydimethyl siloxane, to yield a particle filled fluoropolymer coating composition; and
applying at least one coat of the first fluoropolymer coating composition to a fabric substrate.

3. A process according to claim 2, wherein the fabric substrate is precoated with a second fluoropolymer coating composition that does not contain a ceramic filler material.

4. A process according to claim 2, additionally comprising coating the fabric substrate successively to build up the coating thickness to a desired thickness.

5. A process according to claim 4, additionally comprising applying a third fluoropolymer coating composition to the successively coated fabric substrate to yield a prepreg material on a continuous web.

6. A process according to claim 5, additionally comprising calendaring the prepreg material.

7. A process according to claim 5, additionally comprising cutting the prepreg material into sheets of predetermined length, stacking the sheets and subjecting the stack of sheets to a heat and pressure schedule so as to laminate the sheets.

8. A process according to claim 4 additionally comprising providing layers of conductive material on the outer surfaces of the laminate.

9. A process according to claim 2, wherein said ceramic filler material is selected from silica, titanium dioxide, strontium titanate and alumina.

10. A process according to claim 2, wherein molecular weight of said methyl-terminated polydimethyl siloxane is greater than 1000 Daltons.

11. A process according to claim 2, wherein said fabric substrate is a woven or nonwoven fabric.

12. A process according to claim 2, wherein said fabric substrate comprises fiberglass.

13. An article prepared by the process of any of claims 2.

14. A composite material comprising a reinforcing substrate impregnated with a fluoropolymer composition; said fluoropolymer composition comprising a ceramic filler material, a silicone oil and a fluoropolymer resin, said silicone oil comprising a methyl-terminated polydimethyl siloxane.

15. A composite material according to claim 14 wherein volume percent of said filler particles with respect to total filler and fluoropolymer content ranges from 15% to less than 75%.

16. A composite material according to claim 14 additionally comprising at least one layer of an unfilled fluoropolymer selected from the group consisting of homopolymers or copolymers of TFE, said at least one layer of an unfilled fluoropolymer being stacked with one or more layers comprising said impregnated reinforcing substrate.

17. A composite material according to claim 16 additionally comprising at least one layer of conductive material applied to a portion of at least one surface of said stack, and said layers being laminated, and optionally with a PFA copolymer, MFA, or PTFE skived layer between said conductive layer and said impregnated reinforcing substrate layers in said stack.

18. A composite material according to claim 17 wherein said laminate has a dielectric constant ranging between 2.5 and 15.

19. A composite material according to claim 14 wherein said reinforcing substrate comprises a woven fabric coated with at least one coating of a unfilled fluoropolymeric resin having a dielectric constant of less than 3.

19. A composite material according to claim 14 wherein said reinforcing substrate comprises a woven fabric coated with at least one coating of a unfilled fluoropolymeric resin having a dielectric constant of less than 3.

20. A composite material according to claim 14, wherein said ceramic filler material is selected from silica, titanium dioxide, strontium titanate and alumina.

21. A composite material according to claim 14, wherein molecular weight of said methyl-terminated polydimethyl siloxane is greater than 1000 Daltons.

22. A composite material according to claim 14, wherein said fabric substrate is a woven or nonwoven fabric.

23. A composite material according to claim 14, wherein said fabric substrate comprises fiberglass.
